(19) United States
(12) Patent Application Publication
(10) Pub. No.: US 2018/0335775 A1
(43) Pub. Date: Nov. 22, 2018

(54) AUTOMATIC TRAVELING CONTROL DEVICE

(71) Applicant: HONDA MOTOR CO., LTD., Tokyo (JP)

(72) Inventors: Hitoshi Konishi, Wako-shi (JP); Hirotaka Takiguchi, Wako-shi (JP)

(21) Appl. No.: 15/980,929

(22) Filed: May 16, 2018

(30) Foreign Application Priority Data
May 22, 2017 (JP) 2017-100915

(51) Int. Cl. G05D 1/00; G05D 1/02

(52) U.S. Cl. CPC G05D 1/0061; G05D 1/0274; G05D 1/0088; G05D 2201/0213; G05D 1/0257; G05D 1/0231; G05D 1/0278

(57) ABSTRACT

An automatic traveling control device includes a storage device configured to store a road structure map including at least a position and a shape of each portion of a road, a signal processing device configured to control automatic traveling of a vehicle on the basis of at least the road structure map supplied from the storage device, and a temperature output device configured to measure or estimate a temperature of the storage device. The signal processing device outputs a signal for instructing stopping some or all of automatic driving functions to be executed by the automatic traveling control device when the temperature output from the temperature output device exceeds a predetermined temperature.

### CROSS-REFERENCE TO RELATED APPLICATION

Priority is claimed on Japanese Patent Application No. 2017-100915, filed May 22, 2017, the content of which is incorporated herein by reference.

### BACKGROUND OF THE INVENTION

### Field of the Invention

The present invention relates to a control device for a vehicle, and more particularly, to an automatic traveling control device that controls automatic traveling of a vehicle.

### Description of Related Art

In recent years, the development of an automatic traveling control device that automatically controls the output, steering, and braking of a vehicle has progressed. Such an automatic traveling control device controls automatic traveling of a vehicle on the basis of detection information of a plurality of sensors that detect a position of the vehicle or a traveling environment and high-accuracy map information stored in a storage device in the automatic traveling control device.

In control of automatic traveling of a vehicle, high accuracy is required in both the detection information and the high-accuracy map information. When there is a problem in the reliability of each piece of information, a process of stopping automatic driving of the vehicle and performing switching to manual driving may be necessary.

For example, Japanese Unexamined Patent Application, First Publication No. 2016-95831 (hereinafter referred to as Patent Document 1) discloses an automatic traveling control device that stops some or all of automatic traveling functions and requests a driver to perform switching to manual driving when an abnormality is recognized in detection information from a sensor. However, in Patent Document 1, although an abnormality in the detection information of a sensor is determined on the basis of map information, the accuracy of the map information is not considered.

However, in general, in a case in which data is input to or output from a storage device, when an ambient temperature of the storage device becomes high, an error rate may be high at the time of reading or writing data. For example, according to a traveling environment of the vehicle or the like, a temperature of the storage device in which high-accuracy map is stored may rise to become outside of a recommended ambient temperature range. As a result, it can be assumed that high-accuracy map information may not be accurately read from the storage device or update data of the high-accuracy map may not be accurately written to the storage device.

Further, when an error correction rate of read data or the like becomes high, a data repairing process such as retry-reading for repeatedly reading data may be executed in the storage device. When a frequency of such a process increases, a data reading rate in the storage device greatly decreases, and therefore, a time until data reception in a central processing unit (CPU) of the automatic traveling control device greatly increases. Thus, a processing speed of the CPU may decrease.

When the temperature of a storage device to be used in a vehicle becomes very high in this manner, the reliability of data input to and output from the storage device or the processing speed of the CPU may decrease. Particularly, degradation of capability is caused in an automatic traveling control device in which high-accuracy input and output data and high-speed processing performance for the data are required.

However, in an automatic traveling control device of the related art, processing capability when a temperature of a storage device or a CPU to be used in the control device is high is not considered. For example, in the case of the automatic traveling control device described in Patent Document 1, an output speed of the map information to be output from the storage device may decrease or the processing speed of the CPU may decrease according to a utilization ambient temperature of the storage device.

### SUMMARY OF THE INVENTION

From such a background, an automatic traveling control device capable of reliably switching from manual driving to automatic driving or from automatic driving to manual driving or restricting automatic driving even when the storage device is exposed to a high temperature is desired.

(1) An automatic traveling control device according to an aspect of the present invention includes a storage device configured to store a road structure map including at least a position and a shape of each portion of a road; a signal processing device configured to control automatic traveling of a vehicle on the basis of at least the road structure map supplied from the storage device; and a temperature output device configured to measure or estimate a temperature of the storage device. The signal processing device outputs a signal for instructing stopping some or all of automatic driving functions to be executed by the automatic traveling control device when the temperature output from the temperature output device exceeds a predetermined temperature.

(2) In the aspect of (1), the storage device may be disposed in a same casing as that of the signal processing device, and the temperature output device may measure a temperature of at least a portion of a surface of the casing or an inside of the casing.

(3) In the aspect of (1), the storage device may be disposed in a second casing separate from a first casing in which the signal processing device is disposed, and the temperature output device may measure a temperature of a portion of a surface of the second casing or an inside of the second casing.

(4) In the aspect of (1), the storage device may be disposed in a vehicle cabin of the vehicle, and the temperature output device may measure or estimate a temperature in the vehicle cabin.

(5) In the aspect of (1), the temperature output device may estimate the temperature of the storage device from air temperature information in a current position or a traveling route of the vehicle.

(6) In the aspect of any one of (1) to (5), the automatic driving functions to be stopped may include a function of automatically driving at least one of outputting, steering, and braking of the vehicle.

(7) In the aspect of any one of (1) to (6), the automatic traveling control device may have a function of updating the road structure map according to a traveling position of the vehicle or a version of the road structure map, and may not update the road structure map when the temperature output from the temperature output device exceeds a predetermined temperature.

### BRIEF DESCRIPTION OF THE DRAWINGS

FIG. 1 is a block diagram illustrating a configuration of a vehicle including an automatic traveling control device according to an embodiment of the present invention.

FIG. 2 is a flowchart illustrating an automatic driving stopping process procedure that is executed by the automatic traveling control device according to the first embodiment of the present invention.

FIG. 3 is a flowchart illustrating an automatic driving stopping process procedure that is executed by an automatic traveling control device according to a modification example of the first embodiment of the present invention.

FIG. 4 is a flowchart illustrating an automatic driving stopping process procedure that is executed by an automatic traveling control device according to a modification example of the first embodiment of the present invention.

FIG. 5 is a flowchart illustrating a procedure of updating a road structure map that is executed by an automatic traveling control device according to a second embodiment of the present invention.

FIG. 6 is a flowchart illustrating an automatic driving stopping process procedure that is executed by an automatic traveling control device according to a third embodiment of the present invention.

FIG. 7 is a block diagram illustrating a configuration of a vehicle including an automatic traveling control device according to a fourth embodiment of the present invention.

FIG. 8 is a flowchart illustrating an automatic driving stopping process procedure that is executed by an automatic traveling control device according to a fifth embodiment of the present invention.

### DETAILED DESCRIPTION OF THE INVENTION

Hereinafter, embodiments of the present invention will be described with reference to the drawings. In the embodiments of the present invention, an automatic traveling control device mounted on a vehicle is shown as an example of an automatic traveling control device according to the present invention, but a configuration of the automatic traveling control device according to the present invention is not limited thereto and the present invention can also be applied to a case in which the automatic traveling control device is mounted on a general moving body in a broad sense.

### First Embodiment

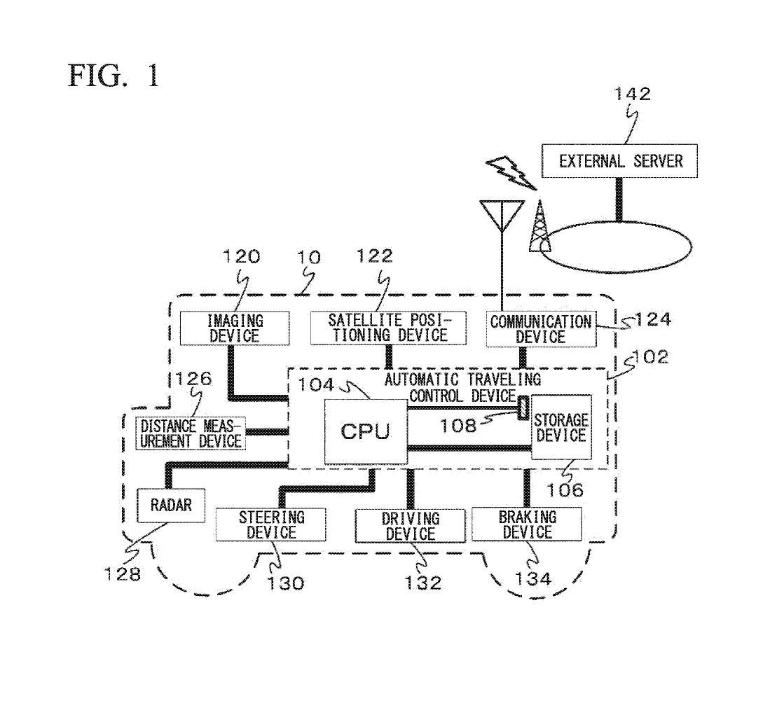

First, the configuration of an automatic traveling control device that controls automatic traveling of a vehicle according to the first embodiment will be described. FIG. 1 is a block diagram illustrating a configuration of a vehicle 10 including an automatic traveling control device 102 according to the first embodiment.

The vehicle 10 includes an automatic traveling control device 102, a detection device including, for example, an imaging device 120, a satellite positioning device 122, a communication device 124, a distance measurement device 126, and a radar 128, which outputs a detection signal to the automatic traveling control device 102, and a traveling operation device including, for example, a steering device 130, a driving device 132, and a braking device 134, which is operated on the basis of a signal output from the automatic traveling control device 102.

The imaging device 120 is a camera including, for example, an optical element such as a lens, and a solid-state imaging element such as a complementary metal oxide semiconductor (CMOS) sensor. The imaging device 120 is attached at, for example, a plurality of locations inside and outside the vehicle cabin, including a rear side of an interior mirror, the vicinity of an upper end of a windshield, and the like, and images other vehicles, obstacles, signs, a road surface, and the like around the vehicle 10 at all times.

The satellite positioning device 122 is configured of a global navigation satellite system (GNSS) receiver or the like and detects a current position of the vehicle 10. The detected current position of the vehicle is output to the automatic traveling control device 102 and used to guide the vehicle 10 on a set traveling route. Further, the current position, for example, is displayed on a map on a display screen of a car navigation system mounted in the vehicle cabin and is used when a route to a destination is determined or information on a road structure at the current position is read from the storage device 106.

The communication device 124 performs wireless communication to connect to an external server 142 over the Internet and receives the latest road structure map from the external server 142 as necessary to update the road structure map such that it is brought into the latest state or receive the latest traffic information or the like. Further, the communication device 124 may have a communication function for a wireless local area network (LAN) and access the Internet or the like via an access point or the like of a nearby public wireless LAN to acquire, for example, information on facilities near the vehicle, such as a parking lot or a shopping center.

The distance measurement device 126 is configured using, for example, Laser Imaging Detection and Ranging (LIDAR) that measures a distance to the target by irradiating a target such as an obstacle or a vehicle ahead of the vehicle 10 with pulsed laser light and measuring a time until scattered light of the laser light returns. The distance measurement device 126 is attached at, for example, a plurality of places such as a front surface or a side surface of a vehicle body.

The radar 128 measures, for example, a distance to a preceding vehicle by temporally changing a frequency of millimeter waves using a frequency modulated continuous wave (FMCW) scheme and performing transmission and reception. The radar 128 is attached to, for example, the front surface of the vehicle body.

The steering device 130 controls a traveling direction of the vehicle 10 and includes, for example, a rack-and-pinion type steering gear mechanism including a pinion provided at one end of a steering shaft and a rack provided on a steering gear box, and a motor connected to the pinion. The motor is driven so that a steering angle set by the automatic traveling control device 102 is obtained, and steering of the vehicle 10 is controlled.

The driving device 132 is configured of, for example, one or both of an engine and a motor, and includes an electronic control unit (ECU) for controlling the engine and/or the motor. The ECU controls an output of the engine and/or the motor on the basis of a set value output by the automatic traveling control device 102 such that driving of the vehicle 10 is controlled.

The braking device 134 is configured of, for example, a brake actuator that adjusts a braking force of each wheel of the vehicle 10. The brake actuator for each wheel is operated on the basis of a set value output by the automatic traveling control device 102 such that braking of the vehicle 10 is controlled.

Next, the automatic traveling control device 102 of the first embodiment will be described. The automatic traveling control device 102 is configured of a computer including, for example, a central processing unit (CPU) 104 that is a signal processing device, and a storage device 106 including a read only memory (ROM) to which a program is written and a random access memory (RAM) for temporarily storing data such as high-accuracy map information and route information. The automatic traveling control device 102 determines an output signal for a traveling operation device including, for example, the steering device 130, the driving device 132, and the braking device 134 on the basis of detection signals that are output from detection devices such as the imaging device 120, the satellite positioning device 122, the communication device 124, the distance measurement device 126, and the radar 128.

Processes according to the following embodiments and modification examples thereof executed by the automatic traveling control device 102 are controlled by the automatic traveling control device 102 which is a computer executing a program. Further, the computer program to be executed by the automatic traveling control device 102 can be stored in the ROM of the storage device 106, any computer-readable storage medium, or the like.

The CPU 104 controls the vehicle 10 according to a control mode (for example, an automatic driving mode or a manual driving mode) selected by the user of the vehicle 10. For example, when the automatic driving mode is selected, the CPU 104 of the automatic traveling control device 102, for example, predicts a future state of the vehicle 10 in a predetermined section on the basis of a detection result output from each detection device at the time of traveling and the road structure map stored in the storage device 106 to optimize a traveling trajectory of the vehicle 10, generates an action plan including a plurality of operation processes (for example, deceleration/acceleration of the vehicle, and change of/keeping in lane) such that the optimized traveling trajectory can be executed in the predetermined section, and sequentially executes the operation process according to the action plan such that the vehicle 10 travels automatically.

It should be noted that when an abnormality or a problem is detected in a detection device such as the imaging device 120 or an operation device such as the steering device 130 even when the automatic driving mode is selected, the CPU 104 outputs a signal to instruct stopping some or all of the automatic driving functions. In the case of each device of the vehicle 10 that has received the signal, such as a car navigation system of the vehicle, notification is performed to indicate the fact that all or some of driving operations are to be transferred to the driver of the vehicle 10 through a display on the screen or the speaker to request manual driving of the driver, or when switching to manual driving of the driver cannot be performed, the vehicle 10 is rapidly automatically moved to a safe place in the vicinity and stopped, or some (for example, only a steering function of the steering device 130) of the automatic driving functions are forcibly stopped.

As the storage device 106, for example, a solid state drive (SSD) including a semiconductor memory such as a NAND flash memory or a magnetoresistive memory such as a magnetoresistive random access memory (MRAM), or any storage means such as a hard disk drive (HDD) can be used. Further, it is also possible to use a plurality of storage means in combination (for example, to use a flash memory and an HDD in combination) according to applications, or it is possible to dispose a plurality of storage means inside a casing constituting the storage device 106 and separately use each storage means, as necessary. It should be noted that in this embodiment, a case in which a NAND type flash memory is used as the storage device 106 will be described below by way of example.

A road structure map to be used in the automatic driving of the vehicle is stored in the storage device 106 in addition to data for temporary storage such as programs to be executed by the CPU 104 or route information. The road structure map includes data regarding a position, a size, and a shape of each portion constituting the road. For example, the road structure map includes numerical data in which positions or shapes of respective portions of the roads constituting roads such as curbs of roads and objects (for example, signs, signals, utility poles, poles, and the like) provided on the roads are indicated with an error of about several cm, and data regarding information on painted patterns (lanes, a stop line, a pedestrian crossing, and the like) painted on the road surface of the road (a shape, a lane type, and lane width information). The road structure map is referred to when successive comparison with information on the surroundings of the vehicle 10 collected by the imaging device 120 or the like is performed or the above-described action plan or the like is generated in the CPU 104. Further, the road structure map is updated through the communication device 124 as necessary and updated information is also stored in the storage device 106.

Here, in the automatic traveling control device 102 of the first embodiment, particularly, a temperature output device 108 that measures or estimates a temperature of the storage device 106 is provided. With this configuration, the CPU 104 monitors the temperature of the storage device 106 through an output temperature from the temperature output device 108 at all times. For example, when the temperature of the storage device 106 is abnormal, the CPU 104 may output a signal indicating a temperature abnormality in the storage device or a signal for instructing stopping some or all of the automatic driving functions to a predetermined device in the vehicle. For example, when it is detected that the temperature of the storage device 106 has exceeded a predetermined temperature in an operation of reading the data from the storage device 106 or an operation of writing data to the storage device 106, the CPU 104 may output a signal to instruct stopping some or all of the automatic driving functions to the predetermined device in the vehicle. It should be noted that, here, the predetermined temperature may be set on the basis of, for example, a guaranteed operating temperature of the storage device 106, a temperature at which a read error or a write error occurs in the storage device 106 a predetermined number of times or more, or a temperature at which a reading rate or a writing speed in the storage device 106 becomes very low and the CPU 104 cannot maintain a defined processing speed.

In the case of a device that has received a signal for instructing stopping of the automatic driving function from the CPU 104, such as the car navigation system of the vehicle, a configuration in which some or all of the automatic driving is transferred to the driver of the vehicle 10 through a display on a screen or a speaker, and the driver is requested to perform an operation can be adopted. Further, a configuration in which the vehicle 10 is rapidly automatically moved to a nearby safe place and stopped, or some of the automatic driving functions (for example, lane changing, overtaking, merging, or turning right or left at an intersection) can be forcibly stopped when transition to an operation by the driver cannot be performed can be adopted.

The temperature output device 108 may be, for example, a temperature sensor. A temperature sensor including a thermistor, a thermocouple type temperature sensor, or a radiation thermometer that monitors, for example, infrared rays that are radiated from a target can be applied. The temperature output device 108 can be configured to come in contact with a surface of the casing of the storage device 106, as illustrated in FIG. 1. In addition, the temperature output device 108 may merely be a single temperature sensor as described above. Further, the temperature output device 108 may adopt a configuration in which an A/D converter that converts an analog signal output from the temperature sensor into a digital signal, a CPU that detects or estimates the temperature of the storage device 106 on the basis of the digital signal, and the like are included, and a temperature signal is transmitted via an in-vehicle LAN without having a dedicated connection line.

It should be noted that the temperature output device 108 need not be a dedicated temperature sensor that monitors the temperature of only the storage device 106 as described above. For example, a temperature sensor that measures a temperature of at least a portion inside the casing can be used in place of the temperature sensor provided in contact with the casing of the storage device 106, and the temperature of the storage device 106 may be determined on the basis of the temperature measured by this temperature sensor. Further, in a case in which the storage device 106 is provided in the vehicle cabin, a thermometer that measures an ambient temperature in the vehicle cabin, such as a temperature sensor for an in-vehicle air conditioner, can be used, and a configuration in which a CPU included in the temperature output device 108 estimates the temperature of the storage device 106 from a temperature detected by an inside air temperature sensor for an air conditioner and outputs the estimated temperature to the CPU 104 may be adopted. It should be noted that, since the air conditioner further includes an outside air temperature sensor that detects a temperature inside the vehicle cabin or a solar radiation amount sensor, the temperature inside the vehicle cabin may be estimated from the outside air temperature or the amount of solar radiation.

Further, the temperature output device 108 is not limited to a device that directly measures a temperature of a target, such as a temperature sensor, and may be configured as, for example, only a CPU that estimates a change in the temperature of the storage device 106 from information on an air temperature in a traveling route of the vehicle 10 acquired via the communication device 124. In such a case, since the temperature sensor is unnecessary, the CPU 104 can also be used in place of the temperature output device 108.

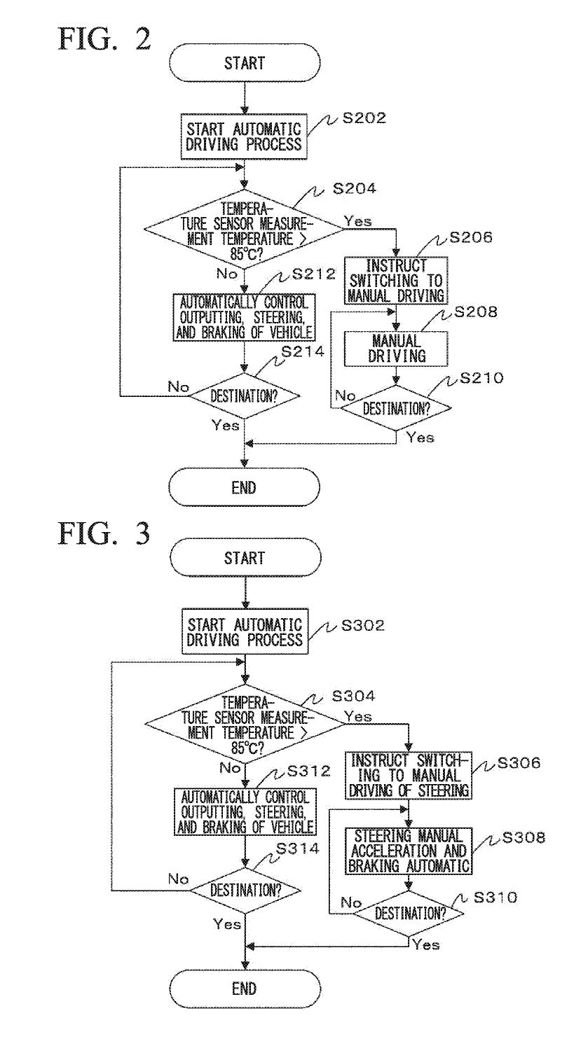

Next, a procedure of a process of stopping automatic driving to be executed by the automatic traveling control device 102 according to the first embodiment will be described with reference to the flowchart of FIG. 2. Here, a NAND type flash memory of which a guaranteed operating temperature is, for example, 85° C. is used as the storage device 106, and a temperature sensor is used as the temperature output device 108 that measures the temperature of the storage device 106. It should be noted that this process ends, for example, at the same time as when the engine of the vehicle started by the user of the vehicle 10 starting up the engine is stopped. At the same time, the outside air temperature and the amount of solar radiation at the time of engine stopping may be acquired, and measurement of a time until the engine is restarted up may be started.

In this process, first, the user of the vehicle 10 selects automatic driving of the vehicle 10 using a button or the like provided in the vehicle cabin (S202). During automatic traveling, the temperature of the storage device 106 is monitored by the temperature sensor 108 at all times. Here, when the temperature of the storage device 106 exceeds 85° C. which is the guaranteed operating temperature of the storage device (S204: Yes), the CPU 104 determines that reading of the road structure map from the storage device 106 becomes unstable, and outputs a signal for instructing stopping of all functions for automatic driving. The car navigation system in the vehicle cabin which has received the signal indicates, for example, that the user of the vehicle 10 is entrusted with all driving through a liquid crystal screen or a speaker (S206). The user of the vehicle 10 performs driving according to the indication (S208), and this process ends at a time when the vehicle has arrived at a destination. Further, in S204, when the temperature of the storage device 106 is within 85° C. (S204: NO), automatic traveling of the vehicle is continued, and the process ends at a point in time of arrival at the destination.

In should be noted that although the configuration in which driving is transferred to the user in S206 has been adopted in the first embodiment, a configuration in which when the traveling operation device such as the steering device 130 that has received a signal for instructing stopping from the CPU 104 rapidly automatically moves the vehicle 10 to a safe place in the vicinity and stops the vehicle 10, for example, may also be adopted. Further, although the configuration in which switching is performed from automatic driving to manual driving in S206, and then manual driving is performed until the vehicle reaches the destination has been adopted in the first embodiment, a configuration in which when the storage device 106 can operate normally when the temperature of the storage device 106 reaches a normal value (<85° C.) during manual driving, the process returns to S212 to switch the vehicle 10 from manual driving to automatic driving again and execute automatic driving may also be adopted.

With such a configuration, it is possible to manage the temperature of the storage device to be used in the vehicle at all times and to prevent degradation of reliability of data input to or output from the storage device and degradation of the processing speed of the CPU due to the degradation of an input or output speed of the storage device. Further, it is possible to inform the driver of an abnormality in the storage device during automatic traveling even when the storage device is abnormal and reliably guide switching to manual driving or stopping of the vehicle, thereby further enhancing safety of an automatically driven vehicle.

### Modification Example 1

The configuration in which all automatic driving is stopped when the temperature of the storage device 106 exceeds the guaranteed operating temperature of 85° C. in the process flow illustrated in FIG. 2 has been adopted, but the present invention is not limited thereto and a configuration in which some of the automatic driving operations are stopped, for example, as in FIG. 3, may be adopted.

FIG. 3 is a process flow that can be used in place of the process flow illustrated in FIG. 2 of the first embodiment. In the process flow according to Modification example 1, when the temperature of the storage device 106 exceeds the guaranteed operating temperature of 85° C., the CPU 104 stops some functions of the automatic driving, for example, functions related to the automatic driving for steering in S306 to S308. A relevant signal is received, the driver is requested to hold the steering wheel, an operation is transferred to the driver, and steering is changed to a manual operation.

This is because even when the road structure map cannot be used, following traveling using control of outputting or braking is possible with respect to a preceding vehicle using the radar 128, for example.

In this modification example, even when the road structure map cannot be used, only the automatic driving related to steering can be released and the automatic driving can be continued for other operations, such that a burden on the user of the vehicle 10 is minimized. It should be noted that since processes that are the same as those in FIG. 2 are performed for steps other than S306 to S308, description thereof will be omitted. In addition, lane keeping control based on a white line on the road surface imaged by the imaging device 120 may be executed, and the driver may be entrusted with control of an output, braking, or both, and a combination including steering can be appropriately performed.

### Modification Example 2

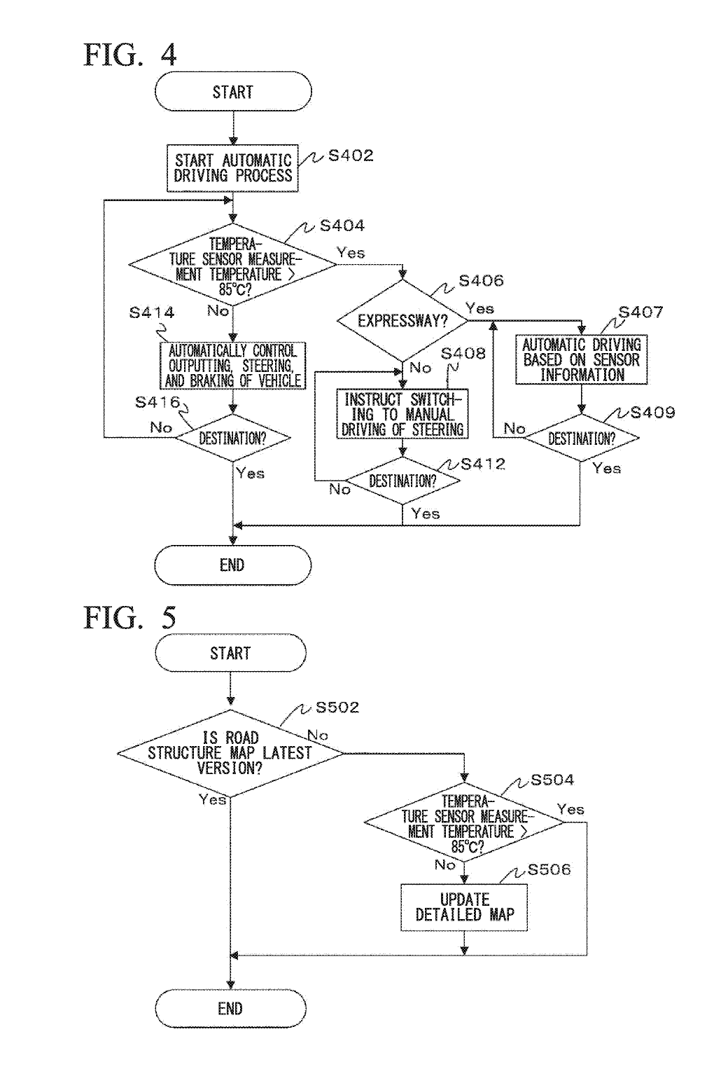

In the process flow illustrated in FIG. 3, automatic driving of at least one of outputting, steering, and braking is stopped when the temperature of the storage device 106 exceeds the guaranteed operating temperature of 85° C., but the present invention is not limited thereto, and the automatic driving may be continued according to a type of a traveling road, for example, as illustrated in FIG. 4.

FIG. 4 illustrates a process flow that can be used in place of the process flow of FIG. 3 of Modification example 1, for example. A difference between the process flow of FIG. 4 and the process flow of FIG. 3 is that even when the temperature of the storage device 106 exceeds the guaranteed operating temperature of 85° C., when the vehicle is traveling on a highway (S406: Yes), the automatic driving based on information detected by the sensor is continued (S407). As described above, even when the road structure map cannot be used, it is possible to continue the automatic driving such as constant speed traveling or preceding vehicle following control while keeping in the same lane even with only sensor information. Therefore, automatic driving is continued even when the temperature of the storage device 106 is high.

Thus, even when the temperature of the storage device is high, a burden on the user of the vehicle 10 is minimized. It should be noted that when the vehicle travels on an ordinary road or the like (S406: No), processes that are the same as those of S406 to S410 of FIG. 3 are performed in S408 to S412, and the automatic driving is switched to manual driving.

### Second Embodiment

Next, a procedure of updating the road structure map stored in the storage device 106 will be described with reference to a flowchart illustrated in FIG. 5. It should be noted that this process is started, for example, when the user of the vehicle 10 starts up the engine of the vehicle and ends at the same time as when the engine is stopped. However, even when the engine of the vehicle 10 is stopped, the communication device 124 can enter a standby state, and therefore, an operation can be performed according to a state of the battery of the vehicle 10 and urgency of the map updating.

In S502, an inquiry is made to the external server 142 (FIG. 1) including the latest road structure map via the communication device 124, a version of the road structure map stored in the storage device 106 is compared with a version of the road structure map stored in the external server 142, and a determination is made as to whether the road structure map stored in the storage device 106 is the latest.

When the road structure map stored in the storage device 106 is the latest (S502: Yes), an updating process ends. On the other hand, when the road structure map stored in the storage device 106 is not the latest (S502: No), the temperature of the storage device 106 is detected by the temperature sensor 108. When the temperature of the storage device 106 does not exceed 85° C. (S504: No), the latest road structure map is downloaded from the external server 142, updating is performed, and the process ends. On the other hand, when the temperature of the storage device 106 exceeds 85° C., the processing ends without updating the road structure map.

By executing the update process in such a procedure, it is possible to avoid updating of the storage device 106 in a high temperature state in which operation is not guaranteed. In addition, it is also possible to avoid an increase in a communication time due to a decrease in a writing speed.

### Third Embodiment

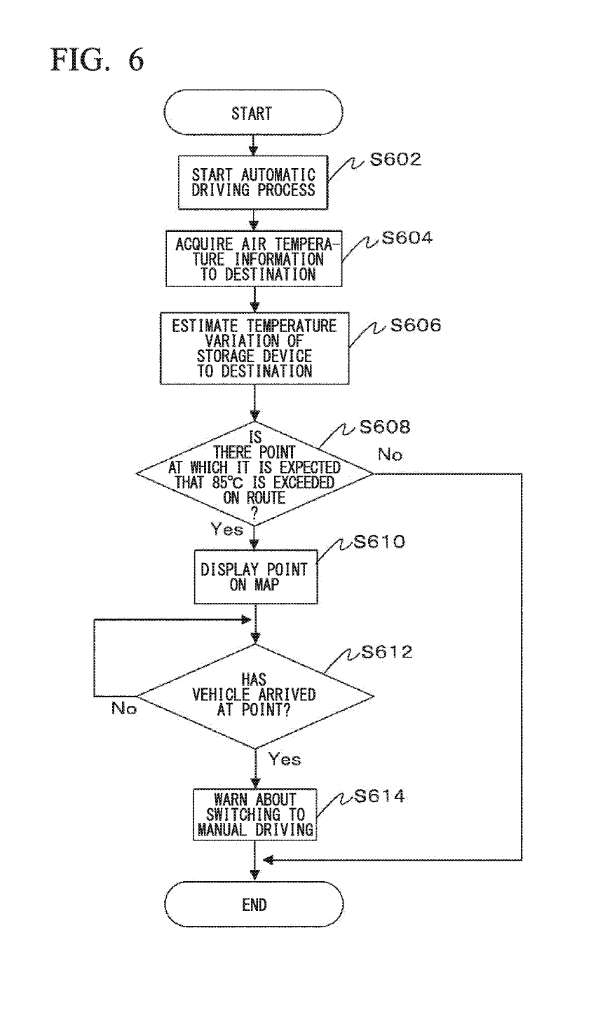

In a third embodiment, the temperature output device 108 estimates change in temperature of the storage device 106 on the basis of the air temperature information or the like and outputs the estimated temperature to the CPU 104, and does not include a temperature sensor. When it is estimated that the estimated temperature estimated by the temperature output device 108 exceeds, for example, the guaranteed operating temperature of the storage device 106, the CPU 104 to which the estimated temperature is input outputs a signal for instructing stopping of some functions of automatic driving, such as functions related to the automatic driving of the steering to each device on the vehicle. For example, in the car navigation system in the vehicle cabin that has received the signal, it is possible to request the user of the vehicle 10, for example, to stop the automatic driving and perform switching to the manual driving through the liquid crystal screen or the speaker. A process procedure according to the third embodiment will be described with reference to a flowchart illustrated in FIG. 6. It should be noted that this process ends, for example, at the same time as when the engine of the vehicle started by the user of the vehicle 10 starting up the engine is stopped.

In this process, first, the user of the vehicle 10 selects automatic driving of the vehicle 10 using a button or the like provided in the vehicle cabin (S602). Then, weather forecast information on an air temperature at an expected passing through time for each point on the traveling route from the current position to the destination is acquired from the Internet via the communication device 124 (S604). Here, the temperature output device 108 estimates the change in temperature of the storage device 106 for each passing point from the current position to the destination when the vehicle 10 is exposed to the expected air temperature, from the acquired prediction information of the air temperature at each expected passing time for each passing point (S606).

Then, in S608, it is determined from the estimated change in temperature of the storage device 106 whether or not there is a point in the traveling route at which the guaranteed operating temperature (for example, 85° C.) of the storage device 106 is exceeded. If there is no point at which 85° C. is exceeded (S608: No), the present process ends. On the other hand, when it is confirmed that there is a point at which 85° C. is exceeded (S608: Yes), a position corresponding to the point is displayed, for example, on a map display screen of the in-vehicle car navigation system (S610), and when the vehicle arrives at the point (S612: Yes), the driver is warned to perform switching to the manual driving (S614), and the present process ends. It should be noted that an aspect in which a countdown for switching from the automatic driving to the manual driving at several minutes before arrival at the position is performed through a display on voice or a navigation screen, such that the switching to the manual driving is performed smoothly and with a margin may be adopted.

In the third embodiment, since the temperature sensor is unnecessary, simplification of the device and reduction in costs can be realized. It should be noted that although the temperature output device 108 is configured to integrate outside air temperature information from the Internet and estimate the temperature of the storage device in the third embodiment, the CPU 104 of the automatic traveling control device 102 may be configured to collect air temperature information and estimate the temperature of the storage device, in place of the temperature output device 108.

Further, a configuration in which, for example, when the vehicle 10 is parked in a parking lot in hot weather in summer, the temperature of the storage device 106 is estimated from the outside air temperature and the amount of solar radiation detected at the time of stopping of the engine, or a parking time, an outside air temperature, an inside air temperature, and the amount of solar radiation detected at the time of startup of the engine, and when the estimated temperature is higher than a predetermined temperature, a display indicating that the automatic driving cannot be performed is performed, an automatic driving request of the driver is not accepted, and the automatic traveling is stopped for a predetermined period of time from driving start of the vehicle 10 can be adopted. Further, in such a case, it is naturally detected that the temperature of the storage device 106 has decreased, and a configuration in which the stopped automatic traveling is started after a certain period of time has elapsed from the start of traveling or when sufficient cooling of the storage device 106 is estimated, for example, from the temperature sensor of the air conditioner in the vehicle cabin may be adopted.

### Fourth Embodiment

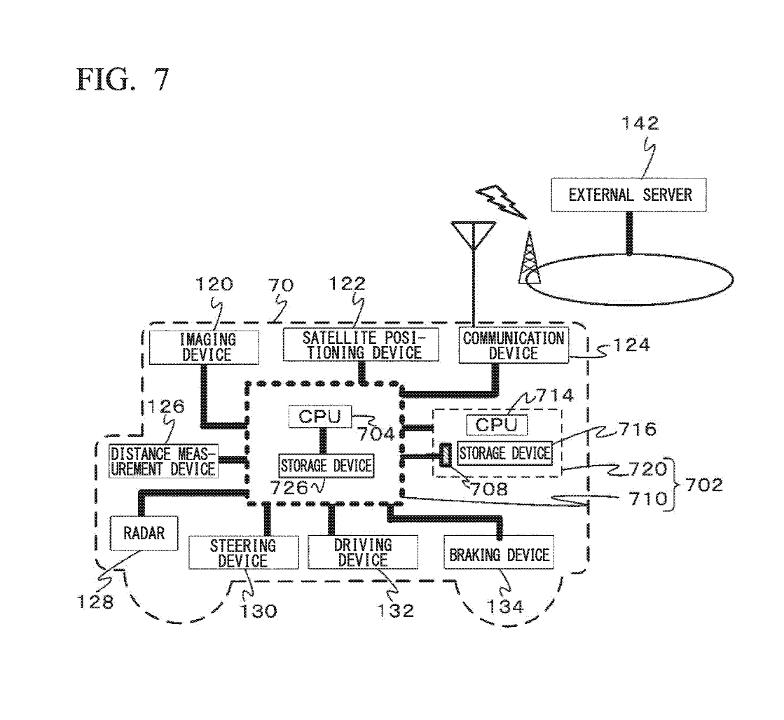

In a fourth embodiment, a storage device in which the road structure map is stored is disposed in a dedicated casing which is a casing different from the casing in which the CPU that controls the automatic traveling is disposed to constitute a map unit. Next, a vehicle 70 having this configuration will be described with reference to a block diagram illustrated in FIG. 7. In the vehicle 70 illustrated in FIG. 7, components the same as those of the vehicle 10 according to the first embodiment illustrated in FIG. 1 are denoted by the same reference numerals as those illustrated in FIG. 1, and the description of FIG. 1 described above will be cited.

In the automatic traveling control device 702 according to the fourth embodiment, an automatic traveling unit 710 and a map unit 720 are configured separately from each other, and a casing of the automatic traveling unit 710 and a casing of the map unit 720 are different casings. A computer including, for example, a CPU 704 that is a signal processing device, and a storage device 726 including a ROM to which a program is written, and a RAM for temporarily storing data such as route information is disposed in the casing constituting the automatic traveling unit 710. A steering device 130, a driving device 132, a braking device 134, and the like are controlled on the basis of detection signals from detection devices such as an imaging device 120, a satellite positioning device 122, a communication device 124, a distance measurement device 126, and a radar 128, and information on a road structure map supplied from the map unit 720.

A storage device 716 in which a road structure map is stored, a CPU 714 that controls input and output of information on the road structure map in the storage device 716, and a temperature sensor 708 that measures a temperature of the storage device 716 and outputs the temperature are disposed in the casing of the map unit 720. It should be noted that since an operation of the automatic traveling control device 702 is the same as that of the automatic traveling control device 102 described in the first embodiment, description thereof will be omitted.

Thus, by separating the automatic traveling unit 710 and the map unit 720 from each other and configuring the automatic traveling unit 710 and the map unit 720 as separate casings, the storage device 716 in the map unit 720 is not affected by, for example, self-heating of the CPU 704 in the automatic traveling unit 710, and therefore, management performance for the temperature of the map unit 720 is improved. In addition, since a degree of freedom of a disposition place of the map unit 720 in the vehicle is increased, the map unit 720 can be disposed, for example, at a place at which it is easy for temperature management to be performed, such as in a vehicle cabin.

### Fifth Embodiment

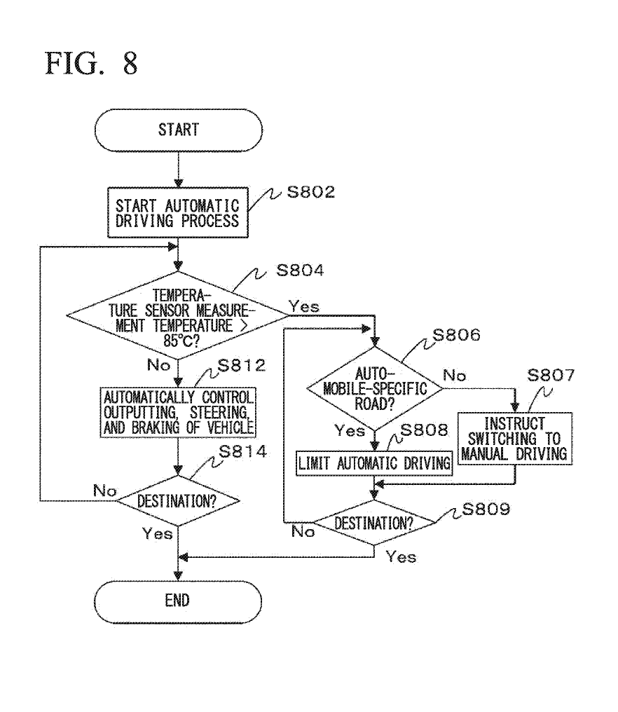

Although the examples of the process in a case in which the vehicle travels on an ordinary road or an expressway have been shown in the first to fourth embodiments and the modification examples thereof, the automatic traveling control device of the present invention can execute the same process as described above, for example, even when the vehicle travels on an automobile-specific road. FIG. 8 illustrates an example of a process that is executed by the automatic traveling control device of the present invention when the vehicle travels on an automobile-specific road. In a case in which the temperature of the storage device 106 exceeds 85° C., which is the guaranteed operating temperature (S804: Yes), when the vehicle travels on an automobile-specific road (S806: Yes), for example, automatic traveling of at least one of outputting, steering, and braking is limited, limited operations are transferred to the driver for changing to a manual operation, and the automatic driving is continued for other operations that have not been limited. It should be noted that, for the other steps of the fifth embodiment, processes that are the same as those in the other embodiments and modification examples thereof are performed, and description thereof will be omitted.

As described above, the automatic traveling control devices 102 and 702 of the present invention are automatic traveling control devices including the storage devices 106 and 716 that store the road structure map including at least the position and the shape of each of portions of a road, the signal processing devices 104 and 704 that control automatic traveling of the vehicle on the basis of at least the road structure map that is supplied from the storage devices 106 and 716, and the temperature output devices 108 and 708 that measure or estimate the temperature of the storage device, and the signal processing device outputs the signal for instructing stopping some or all of the automatic driving functions to be executed by the automatic traveling control device when the temperature output from the temperature output device exceeds the predetermined temperature. Accordingly, it is possible to manage the temperature of the storage device to be used in the vehicle at all times, to prevent degradation of reliability of the data input to or output from the storage device or degradation of a processing speed of the CPU due to the degradation of the input or output speed of the storage device and to inform the driver of an abnormality in the storage device during the automatic traveling even when the storage device is abnormal and reliably perform a guide to switching to the manual driving or stopping of the vehicle, thereby further enhancing safety of an automatically driven vehicle.

It should be noted that the present invention is not limited to the above-described embodiments and can be modified and used without departing from the gist of the present invention.

What is claimed is:

1. An automatic traveling control device, comprising:
a storage device configured to store a road structure map including at least a position and a shape of each portion of a road;
a signal processing device configured to control automatic traveling of a vehicle on the basis of at least the road structure map supplied from the storage device; and
a temperature output device configured to measure or estimate a temperature of the storage device, wherein:
the signal processing device outputs a signal for instructing stopping some or all of automatic driving functions to be executed by the automatic traveling control device when the temperature output from the temperature output device exceeds a predetermined temperature.

2. The automatic traveling control device according to claim 1,
wherein the storage device is disposed in a same casing as that of the signal processing device, and
the temperature output device measures a temperature of at least a portion of a surface of the casing or an inside of the casing.

3. The automatic traveling control device according to claim 1,
wherein the storage device is disposed in a second casing separate from a first casing in which the signal processing device is disposed, and
the temperature output device measures a temperature of a portion of a surface of the second casing or an inside of the second casing.

4. The automatic traveling control device according to claim 1,
wherein the storage device is disposed in a vehicle cabin of the vehicle, and
the temperature output device measures or estimates a temperature in the vehicle cabin.

5. The automatic traveling control device according to claim 1,
wherein the temperature output device estimates the temperature of the storage device from air temperature information in a current position or a traveling route of the vehicle.

6. The automatic traveling control device according to claim 1,
wherein the automatic driving functions to be stopped include a function of automatically driving at least one of outputting, steering, and braking of the vehicle.

7. The automatic traveling control device according to claim 1,
wherein the automatic traveling control device has a function of updating the road structure map according to a traveling position of the vehicle or a version of the road structure map, and does not update the road structure map when the temperature output from the temperature output device exceeds a predetermined temperature.
